(19) United States
(12) Patent Application Publication
(10) Pub. No.: US 2026/0057654 A1
(43) Pub. Date: Feb. 26, 2026

(54) INTERPOLATING STREAM DATA

(71) Applicant: International Business Machines Corporation, Armonk, NY (US)

(72) Inventors: Devyani Lambhate, Bangalore (IN); Vijay Ekambaram, Chennai (IN); Ranjini Bangalore Guruprasad, Bangalore (IN); Kamal Chandra Das, New Delhi (IN); Michiaki Tatsubori, Oiso (JP); Daiki Kimura, Midori-ku (JP); Naomi Simumba, Yokohama (JP)

(73) Assignee: International Business Machines Corporation, Armonk, NY (US)

(21) Appl. No.: 18/814,844

(22) Filed: Aug. 26, 2024

(51) Int. Cl. G06V 10/80; G06V 10/82

(52) U.S. Cl. CPC G06V 10/803; G06V 10/82

(57) ABSTRACT

Methods, computer program products, and systems are presented. The method computer program products, and systems can include, for instance: applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model; and determining an embedding loss function between the first embedding and the second embedding.

### BACKGROUND

Embodiments herein relate generally to stream data and particularly to interpolating stream data.

Data structures have been employed for improving operation of a computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model; determining an embedding loss function between the first embedding and the second embedding; finding a reconstructive loss function between the first reconstructed stream and the first data stream; calculating a reconstructive loss function between the second reconstructed stream and the second data stream; updating weights of the predictive model in dependence on the determining, the finding, and the calculating; repeating the applying, the inputting, the determining, the finding, the calculating, and the updating for multiple iterations of training of the predictive model using subsequent samples of the first data stream and the second data stream; deploying the predictive model; and interpolating the second data stream from the first data stream using the predictive model subsequent to the deploying.

In another aspect, a computer program product can be provided. The computer program product can include a computer readable storage medium readable by one or more processing circuit and storing instructions for execution by one or more processor for performing a method. The method can include, for example: applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model; determining an embedding loss function between the first embedding and the second embedding; finding a reconstructive loss function between the first reconstructed stream and the first data stream; calculating a reconstructive loss function between the second reconstructed stream and the second data stream; updating weights of the predictive model in dependence on the determining, the finding, and the calculating; repeating the applying, the inputting, the determining, the finding, the calculating, and the updating for multiple iterations of training of the predictive model using subsequent samples of the first data stream and the second data stream; deploying the predictive model; and interpolating the second data stream from the first data stream using the predictive model subsequent to the deploying.

In a further aspect, a system can be provided. The system can include, for example a memory. In addition, the system can include one or more processor in communication with the memory. Further, the system can include program instructions executable by the one or more processor via the memory to perform a method. The method can include, for example: applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model; determining an embedding loss function between the first embedding and the second embedding; finding a reconstructive loss function between the first reconstructed stream and the first data stream; calculating a reconstructive loss function between the second reconstructed stream and the second data stream; updating weights of the predictive model in dependence on the determining, the finding, and the calculating; repeating the applying, the inputting, the determining, the finding, the calculating, and the updating for multiple iterations of training of the predictive model using subsequent samples of the first data stream and the second data stream; deploying the predictive model; and interpolating the second data stream from the first data stream using the predictive model subsequent to the deploying.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, data sources, user equipment (UE) devices, and one or more application program interface (API) service endpoint according to one embodiment;

FIG. 2 is a schematic diagram of a machine learning predictive model according to one embodiment;

FIG. 3 is a flowchart illustrating a method for performance by a manager system interoperating with data sources, UE devices and one or more API service endpoint according to one embodiment;

FIG. 4 is a schematic diagram of a machine learning predictive model according to one embodiment;

FIG. 5 is a schematic diagram of a machine learning predictive model according to one embodiment;

FIG. 6 depicts an artificial neural network (ANN) according to one embodiment;

FIG. 7 depicts a computing environment according to one embodiment.

### DETAILED DESCRIPTION

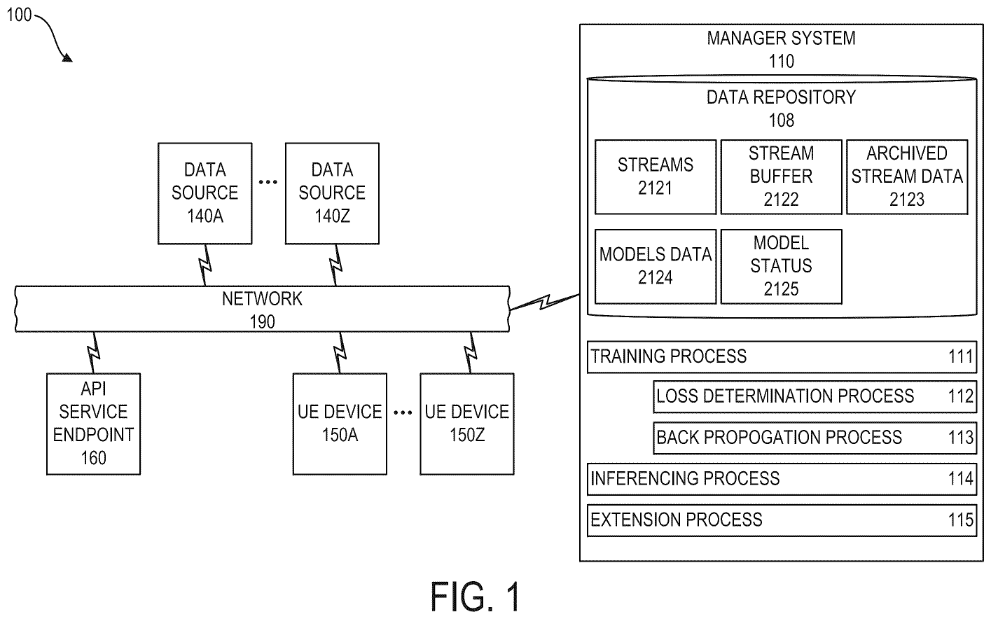

System 100 for interpolating data stream data is shown in FIG. 1. System 100 can include manager system 110, data sources 140A-140Z, user equipment (UE) devices 150A-150Z, and one or more API service endpoint 160. Manager system 110, data sources 140A-140Z, UE devices 150A-150Z, and the one or more API service endpoint 160 can be computing node based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

Manager system 110 can be configured to manage training and inferencing of one or more predictive model. The one or more predictive model can be trained to interpolate data stream data, e.g., second data stream data based on first data stream data or vice versa.

Embodiments herein recognize that where a plurality of data sources are deployed to obtain characterizing data characterizing a common entity, differences can exist with respect to the characterizing data of the multiple data sources. Embodiments herein recognize, for example, that different data source can have different sampling rates. Also, embodiments herein recognize that different data sources can include different sensitivities, e.g., a first data source can be a satellite-based camera image sensor sensing over first spectral band, and a second data source can be a second satellite-based camera image sensor sensing at a second spectral band. In another example, a first data source can be a satellite-based camera image sensor with a first pixel resolution, and a second data source can be a second satellite-based camera image sensor with a second pixel resolution. In another example, the first data source can be configured for sensing of the presence of a chemical substance, and the second data source can be a data source producing text-based descriptions of anthropogenic events. In another example, the first data source can be satellite-based camera image sensor, and a second data source can be a ground-based camera image sensor. In another example, the first data source can be a camera image sensor producing pixelated camera image data representing a first geographical area, and a second data source can be a chemical substance sensor that produces a single data value representing the presence of a chemical substance over the geographical area. Numerous additional examples can be conjectured.

Embodiments herein recognize that interpolate missing data stream data of a second data stream based on data stream data of the first data stream can be beneficial. Interpolating data stream data can be beneficial, e.g., in the case that a sampling rate of a second data source is too slow to satisfy the requirements of a particular application. In another example, the second data source can be out of service.

Data repository 108 can store various data. Data repository 108 in streams area 2121 can store data on data streams available within system 100. In system 100, there can be provided a plurality of data sources 140A-140Z, each data source generating a respective data stream. Data sources 140A-140Z can be provided, e.g., by pixel-based camera image sensor, e.g. satellite for ground-based chemical substance sensors, substance sensors, text publication platforms e.g., social media platforms and the like.

Data repository 108 in streams area 2121 can store data identifying data stream available within system 100, wherein each data stream can map to particular one data source of data sources 140A-140Z. System 100 can be configured so that when each new stream is identified, manager system 110 can assign a universal unique identifier (UUID) to the data stream, which UUID can be recorded with an streams area 2121. Within streams area 2121, there can be recorded a manifest specifying attributes of each data stream, e.g., specifying, e.g., the sampling rate of the data stream, the number of bytes per sample, a friendly name description of the data stream, and the like. In streams area 2121, data repository 108 can store current status table that specifies for each data source 140A-140Z, whether information specifying whether the respective data source of data sources 140A-140Z is actively producing a data stream and other information such as the time of the last sample of particular data stream of the respective data streams. In one aspect, all data stream data from data sources 140A-140Z can be time stamped.

Data repository 108 in stream buffer area 2122 can buffer data streams produced from data sources 140A-140Z. In one aspect, as set forth herein, manager system 110 can apply stream data of data streams for training one or more predictive model. In some use cases, manager system 110 when performing training can filter out certain samples from one or more data source. In one example, for synchronizing data of first and second data streams, manager system 110 can filter out and discard samples of a first data stream for which there is no corresponding timestamp in a second data stream.

Data repository 108 in archived stream data area 2123 can store archived data of data streams collected using system 100. In one use case, while a majority of data stream data can be discarded, archived stream data area 2123 provides a location for storing archived stream data of the various data streams. Within archived stream data area 2123, in one example, there can be stored snapshot samples of data streams of each data source 140A-140Z e.g. archived at an archiving rate less than the native sampling rate of the data source.

In some scenarios, a sampling rate of a data source of data sources 140A-140Z can be low enough that all samples of such data stream and data source can be stored within archived stream data area 2123.

In models area 2124, data repository 108 can store trained predictive models trained by manager system 110. Trained predictive models herein can include trained predictive models that have been trained with use of streaming data from data sources 140A-140Z. Predictive models herein, according to one embodiment, can be configured according to an encoder/decoder machine learning predictive model architecture. According to the encoder/decoder architecture, there can be provided an encoder network and a decoder network. Each of the encoder network and the decoder network can comprise one or more artificial neural network (ANN). The ANNs can be of the same or different architecture. The encoder network of the machine learning predictive model can produce a context vector based on input data that is input into the encoder network. The described encoder network can generate an embedding defined by context vector in dependence on input data that is input into the encoder network. The embedding provided by the context vector in turn can be input into the decoder network and the decoder network in turn can output a reconstructed representation of the input data.

Data repository 108 in model status area 2125 can store status data on various models stored in models area 2124. Model statuses specified within model status area 2125 can specify, e.g., models which have been qualified for production of interpolated data stream data.

Manager system 110 can run various processes. Manager system 110 running training process 111 can include manager system 110 training a machine learning predictive model, such as an encoder decoder based machine learning predictive model. Training process 111 for training a predictive model can include a loss determination process 112 and a backpropagation process 113.

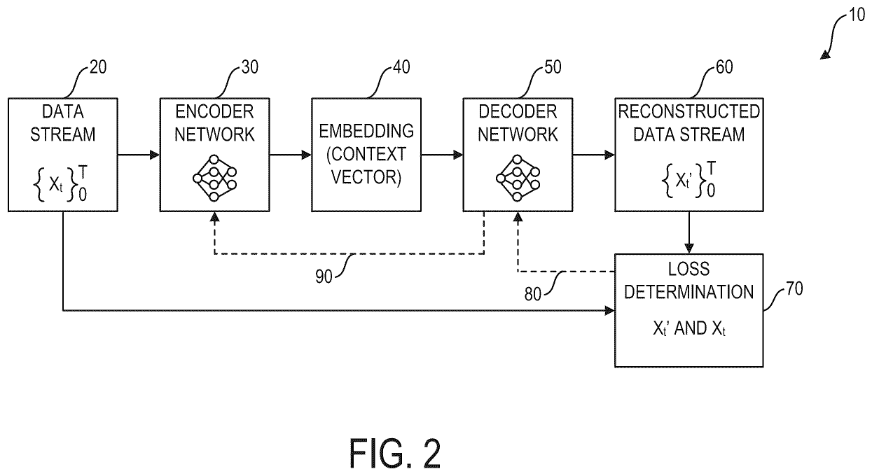

FIG. 2 depicts training of machine learning predictive model 10 provided by an encoder/decoder based machine learning predictive model. Referring to FIG. 2, a sample of data stream Xt in a forward pass can be input into encoder network 30. Encoder network 30 in turn can output an embedding 40 defined by a context vector. The embedding 40 in turn can be input into decoder network 50. Based on the inputting of embedding 40, decoder network 50 can output a sample of reconstructed data stream 60.

For performing training of machine learning predictive model 10 according to one aspect, the sample of reconstructed data stream 60 can be compared to a sample of input data stream 20 for determination of a reconstructive loss function, and a gradient of the reconstructive loss function with respect to the sample of the reconstructed data stream.

The gradient of the loss function can be backpropagated as indicated by 80 to decoder network 50 which can compute gradients of the loss function with respect to decoder weights of decoder network 50 and embedding 40. Decoder weights of decoder network 50 can be updated based on the computed decoder gradients. The gradient of the loss function can be backpropagated as indicated by 90 to encoder network 30 which can compute gradients of the loss function with respect to encoder weights of encoder network 30. Encoder weights of encoder network 30 can be updated based on the computed encoder network gradients.

Backpropagating reconstructive loss in an encoder-decoder architecture can provide dimensionality reduction by learning compact latent representations, noise reduction for denoising applications, and high-quality data reconstruction essential for tasks like image compression. Backpropagating reconstructive loss can enable anomaly detection by producing higher reconstruction errors for abnormal data and can aid in the understanding data through latent space visualization and can provide a regularization mechanism, improving generalization and preventing overfitting. Trained as described, predictive model 10 produces an embedding 40 that increases in accuracy over time.

In various use cases, manager system 110 can perform loss calculations and associated backpropagations additionally or alternatively relative to those depicted in FIG. 2. In one aspect, as set forth herein, the manager system 110 determine a loss function for losses between a second embedding of a second data stream and a first embedding of a first data stream. The gradient of the embedding-to-embedding loss function can be backpropagated to encoder network 30 which can compute gradients of the loss function with respect to encoder weights of encoder network 30. Based on the determined embedding to embedding loss function and the computed gradients of the loss function with respect to encoder weights of encoder network 30, manager system 110 running backpropagation process 113 can adjust one or more weight of encoder network 30. Based on the determined embedding-to-embedding loss function, manager system 110 can also adjust one or more weight of a second encoder network that produces the second embedding. In another aspect, manager system 110 can train a decoder output of decoder for a first stream on a second stream.

Manager system 110 running inferencing process 114 can perform inferencing of a trained predictive model trained by training process 111. In one use case, manager system 110 running inferencing process 114 can include manager system 110 presenting model prompting data to a trained model so that data stream data can be interpolated. In one use case of manager system 110 running inferencing process 114, manager system 110 can apply first data stream to a first encoder network which can produce an embedding of the first data stream. The first embedding can be sent to a decoder network trained to decode a second data stream In the described inferencing process, the decoder network trained to decode a second embedding of a second data stream can produce a recovered second data stream based on input data provided first data stream. Second data stream data can thus be interpolated based on first data stream data.

Manager system 110 running extension process 115 can configure a trained predictive model to accommodate input and inferencing based on an additional one or more stream on the satisfaction of one or more criterion.

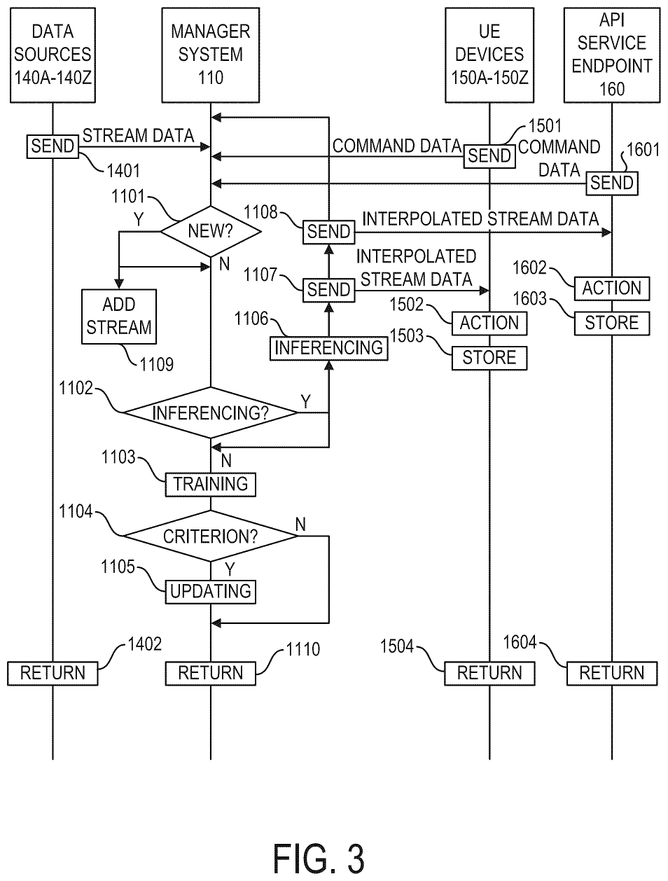

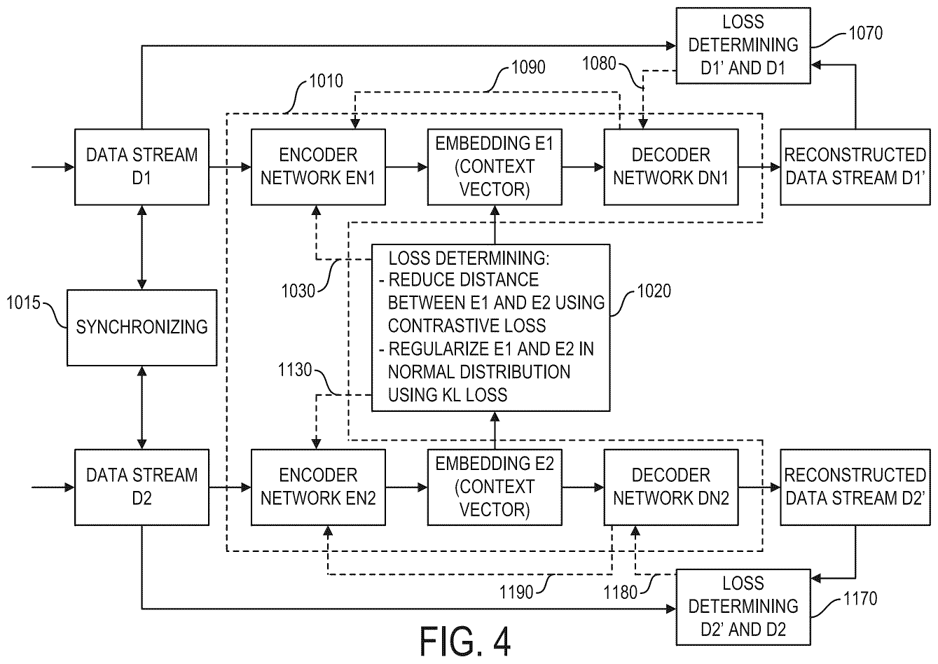

A method for performance by manager system 110 interoperating with data sources 140A-140Z and UE devices 150A-150Z is shown in FIG. 3. The flowchart of FIG. 3 depicts a process whereby manager system 110 can train and inference machine learning predictive model 1010 as set forth in reference to FIG. 4. Data sources 140A-140Z can be sending streaming data for receipt by manager system 110, which can be buffering received stream data into stream buffer 2122. At block 1401, data sources 140A-140Z can be sending stream data for receipt by manager system 110, which can be buffering the stream data on receipt of the stream data.

At block 1501 and 1601, UE devices 150A-150Z and API service endpoint 160 can be sending command data for receipt by manager system. The command data can include command data, e.g., to register a new data source of data sources 140A-140Z or command data to initiate inferencing of a trained predictive model such as machine learning predictive model 1010 as set forth herein.

On receipt of the stream data sent at block 1401 and any command data sent at block 1501 and/or block 1601, manager system 110 can proceed to new stream decision block 1101. At new stream decision block 1101, manager system 110 can ascertain whether any new stream data has been received by manager system 110. For ascertaining whether any stream data is new stream data, manager system 110 at new stream decision block 1101 can examine stream data of received streams in combination with stream reference data stored in streams area 2121 of data repository 108.

Where the examined stream data does not match any reference stream data stored in streams area 2121, manager system 110 can ascertain that new stream data has been received and can proceed to add stream block 1109 to reconfigure machine learning predictive model 1010 as set forth herein to produce predictions in connection with the new stream.

Data stored for each different stream referenced within the data store for each stream in streams area 2121 can define stream referencing data. When stream data is received by manager system 110, manager system 110 can examine stream data for each stream in connection with stream referencing data stored in streams area 2121 to ascertain whether any stream data being received is new stream data from a new stream newly added into system 100.

On determination at new stream decision block 1101 that a new stream has not been added, manager system 110 can proceed to inferencing decision block 1102. Manager system 110 can also proceed to inferencing decision block 1102 on the condition that manager system 110 determines at new stream decision block 1101 that a new stream has been received.

At inferencing decision block 1102, manager system 110 can ascertain whether inferencing of a trained machine learning predictive model 1010 has been invoked by command data received by manager system 110 from the command data sending at block 1501 and/or block 1601.

On the determination at inferencing decision block 1102 that inferencing has not been invoked, manager system 110 can proceed to training block 1103. Manager system 110 can proceed to training block 1103 after inferencing determination block 1102, also on the condition at inferencing determining block 1102 that inferencing has been invoked.

At training block 1103, manager system 110 can perform training of machine learning predictive model 1010 as set forth in reference to FIG. 4. Machine learning predictive model 1010 can feature an encoder/decoder architecture. Machine learning predictive model 1010 can include an encoder network EN1 for encoding a first data stream to produce embedding E1 provided by a context vector, and decoder network DN1 for decoding embedding E1. Decoder network D1, in turn, can produce reconstructed data stream D1′. Machine learning predictive model 1010 can further include encoder network EN2 for encoding a second data stream D2 for producing a second embedding E2, as well as decoder network DN2 that decodes second embedding E2 for generation of reconstructed data stream D2′.

Forward pass training of machine learning predictive model 1010 can include applying data stream D1 to encoder network EN1 and applying data stream D2 to encoder network EN2. When applying the described data streams D1 and D2, the data streams can be synchronized as indicated by synchronizing block 1015.

In one embodiment of performing synchronizing by synchronizing block 1015, certain samples from data stream D1 and/or data stream D2 can be filtered out and discarded. In one aspect, data stream D1 and data stream D2 can have different sampling rates.

In one embodiment, the first data stream D1 can be represented as {xti} sampled at times ti=i·T1 for i=0,1,2, . . . , N−1, with a sampling interval T1. The second data stream D2 can be represented as {ytj}, sampled at times tj=j·T2 for j-0,1,2, . . . , M−1, with a sampling interval T2. In one example, as depicted in Table A, data stream D1 can be sampled every 1 minute (T1=1) and data stream D2 can be sampled every 2 minutes.

TABLE A

| Timestamp | Stream D1 | Stream D2 |
|---|---|---|
| 0 m | sampled | sampled |
| 1 m | sampled | [no sample] |
| 2 m | sampled | sampled |
| 3 m | sampled | [no sample] |
| 4 m | sampled | sampled |
| 5 m | sampled | [no sample] |
| 6 m | sampled | sampled |
| 7 m | sampled | [no sample] |
| . . . | . . . | . . . |

For performing synchronizing at synchronizing block 1015, manager system 110 in one embodiment can perform time synchronizing. For performing time synchronizing, according to one embodiment, manager system 110 can discard samples from the second data stream D2 having timestamps for which there is no matching timestamp from data stream D1. Referring to the specific example of Table A, manager system 110 can discard the samples (buffered in stream buffer 2122) timestamped at times 1m, 3m, 5m, . . . from data stream D2.

In reference to Table A, a simplified synchronization scheme is depicted in which samples from data stream D1 and data stream D2 are selected based on a time factor. In some embodiments, manager system 110 can implement a synchronization scheme in which samples for application of training data into machine learning predictive model 1010 can be selected based on multiple factors, such as two or more of the factors depicted in Eq. 1 below.

$$S = F 1 W 1 + F 2 W 2 + F 3 W 3 \qquad ( Eq . 1 )$$

Where F1 is a first factor for evaluation of a candidate sample from stream D2 for association in a training iteration with a sample from stream D1, F2 is a second factor for evaluation of a candidate sample from stream D2 for association in a training iteration with a sample from stream D1, F3 is a third factor for evaluation of a candidate sample from stream D2 for association in a training iteration with a sample from stream D1, and W1-W3 are weights associated to the various factors. It will be understood that Eq. 1 can additionally or alternatively be used for selecting a candidate sample from stream D1 for association, in a training iteration, with a sample from stream D2.

In one embodiment, F1 can be a timestamp factor, F2 can be a translation factor, and F3 can be an affinity factor.

In assigning scoring values to a candidate sample under the timestamp factor F1, manager system 110 can scale scoring values in dependence on a timestamp difference between the compared data stream D1 sample and the data stream D2 sample. For example, manager system 110 can assign a factor F1 scoring value of 1.0 for compared samples having identical time stamps and can scale scoring values downward from 1.0 (to a minimum of 0.0) depending on the magnitude of the time difference of the compared samples.

In assigning scoring values to a candidate sample under factor F2, manager system 110 can scale scoring values in dependence on a determined translation loss between the compared data stream D1 sample and the data stream D2 sample. Translation loss in the context of comparing images can refer to loss or error introduced when there is a misalignment between two images due to a translation (i.e., a shift in position along the x and/or y axes). Translation loss can occur when one image is slightly shifted relative to another. To derive a loss metric that specifies translation loss, manager system 110 can calculate an initial error between two potentially misaligned images using a metric, e.g., root mean square error (RMSE). Manager system 110 can then systematically shift one image relative to the other across various x and y positions, recalculating the error at each step to find the translation that minimizes this error. Manager system 110 in one embodiment can determine a translation loss by subtracting the minimum aligned error from the initial error, quantifying how much of the original discrepancy was due to the misalignment. In one example, manager system 110 can assign a factor F2 scoring value of 1.0 for compared samples having zero translation loss and can scale scoring values downward from 1.0 (to a minimum of 0.0) depending on the magnitude of the determined translation loss of the compared samples.

For performing pixel-wise RMSE between two images, manager system 110 can first loads the images and converts them into numeric arrays. Manager system 110 can then subtract pixel values of one image from the corresponding pixel values of the other and can square the differences emphasize larger errors. Manager system 110 can determine the mean of these squared differences and can output the square root of this mean as the RMSE. This RMSE value represents the average deviation between the pixels of the compared sampled image, with a lower RMSE indicating greater similarity.

In assigning scoring values to a candidate sample under factor F3, manager system 110 can scale scoring values in dependence on a determined affinity metric between the compared data stream D1 sample and the data stream D2 sample. For determining the reference affinity metric between a stream D1 sample and a candidate D2 sample, manager system 110 can employ rules as are summarized in Table B.

TABLE B

| | |
|---|---|
| 1. | Reconstruct a sample image of stream D1 at the D1 sample time from other sample images |
| | from data streams D2-DN for the same location but at differentiated timings. |
| 2. | Compute the difference (e.g., using pixel-wise RMSE) between the actual D1 sample |
| | image and the reconstructed sample image of D1. |
| 3. | Reconstruct a sample image of stream D2 at the D2 candidate sample time from other |
| | sample images from data streams D1, D3-DN for the same location but at differentiated |
| | timings. |
| 4. | Compute the difference (e.g., using pixel-wise RMSE) between the actual D2 sample |
| | image and the reconstructed sample image of D2. |
| 5. | Aggregate both differences (e.g., by multiplication) as affinity loss. |

Accordingly, in reference to Table B, a synchronizing between samples is set forth herein, wherein the synchronizing includes evaluating candidate samples of the first data stream and/or the second stream for association in a training iteration according to an affinity factor, wherein according to the affinity factor, a reconstructed instance of a sample of the first data stream at a certain time is produced based on sample images from multiple data sources at differentiated times, and a difference is determined between the reconstructed instance of the sample of the first data stream at the certain time and an actual sample of the first data stream at the certain time. In assigning scoring values to a candidate sample under factor F3, manager system 110 can scale scoring values in dependence a determined affinity metric between the compared data stream D1 sample and the data stream D2 sample. For example, manager system 110 can assign a factor F3 scoring value of 1.0 for compared samples zero affinity loss as calculated using the method of Table B and can scale scoring values downward from 1.0 (to a minimum of 0.0) depending on the magnitude of the determined affinity loss between the compared samples.

In reference to synchronizing block 1015, manager system 110 can generate an ordered list of samples from different data streams, e.g., data stream D1 and data stream D2, and can select the sample from data stream D2 (and/or D1) for association in a training iteration in dependence on the ranking (e.g., can select the highest ranked sample). Samples that are not selected can be discarded and not used for training. The techniques described in reference to Eq. 1 and Table B facilitate high quality pairing and synchronizing of samples from different data streams, e.g., data stream D1 and data stream D2, even in the case where samples having matched timestamps are not available.

For performing an iteration of training in a forward pass, machine learning predictive model 1010 with a sample of data stream D1 synchronized to a sample of data stream D2, manager system 110 can perform loss determining in a manner depicted in reference to block 1020. At block 1020, manager system 110 can reduce the distance between embedding E1 and embedding E2 using contrastive loss. For performing loss determining at block 1020, manager system 110 can determine a contrastive loss between embedding E1 and embedding E2. For determining such contrastive loss, manager system 110 can compute the Euclidean distance between the two embeddings. This distance represents how far apart the embeddings are in the embedding space. For determining such contrastive loss, manager system 110 can employ a label to indicate whether the embeddings are from similar or dissimilar samples. A label of 1 indicates similar samples, and a label of 0 indicates dissimilar samples. If the samples are similar, the loss function penalizes large distances, encouraging the embeddings to be close. The penalty increases as the distance exceeds a certain margin. If the samples are dissimilar, the loss function reflects the squared distance, penalizing embeddings that are too close, thus pushing them apart. The total contrastive loss can be a combination of the penalties for both similar and dissimilar samples, ensuring that similar samples are close together and dissimilar samples are far apart in the embedding space. For encouraging embedding E1 to be close to embedding E2, manager system 110 can apply the label 1 to the contrastive loss determination to specify that the samples are similar. The application of label 1 can be qualified on determination that an initial Euclidian distance between E1 and E2 at the time of the first training iteration satisfies a Euclidian distance threshold.

With the contrastive loss determined between the embeddings E1 and E2 determined, manager system 110 can calculate the gradient of the loss with respect to the embeddings E1 and E2, backpropagate at 1030 and 1130 the determined gradients using the chain rule to the respective encoder networks EN1 and EN2, calculate the encoder gradients in dependence on the backpropagated gradients, and update the weights of encoder network EN1 and EN2 based on the calculated encoder gradients.

At loss determining block 1020, manager system 110 can regularize embedding E1 and E2 in a normal distribution using Kullback-Leibler (KL) loss. To regularize embeddings E1 and E2 in a normal distribution using KL loss, manager system 110 can first compute the mean and variance of each embedding and then can calculate the KL divergence between the normal distribution defined by these statistics and a standard normal distribution. For each embedding, the KL loss can be given as ½ (σ²+μ²−1−logσ²). Manager system 110 at loss determining block 1020 can sum the KL losses for both embeddings to get the total KL loss and can combine this with the primary loss function (e.g., contrastive loss) to form the total loss, weighted by a factor 2. Manager system 110 at 1030 and 1130 can backpropagate this total loss to update the model parameters, ensuring the embeddings follow a normal distribution, backpropagate this total loss to update the model parameters, ensuring the embeddings follow a normal distribution.

To backpropagate the total loss and update model parameters, manager system 110 can first pass the input data through the model to obtain embeddings E1 and E2, compute the primary loss (e.g., contrastive loss) and calculate the KL loss for each embedding by determining their mean and variance and then applying the KL divergence formula. Manager system 110 can combine the primary and KL losses into a total loss, weighted appropriately. Manager system 110 can backpropagate this total loss to calculate gradients with respect to the weights of respective encoder network EN1 and EN2, incorporating the gradients from both the primary and KL losses. Manager system 110 can further update weights of encoder network EN1 and EN2 using an optimization algorithm, e.g., gradient descent, ensuring that the embeddings follow a normal distribution while also minimizing the primary loss.

In a further aspect of training at training block 1103, manager system 110 can perform loss determining at block 1070 and loss determining at block 1170. At loss determining block 1070, manager system 110 can determine a loss between the reconstructed data stream D1′, and the original input data stream D1. At loss determining block 1170, manager system 110 can perform loss determining to determine a loss between reconstructed data stream D2′ and original data stream D2.

For performing training of machine learning predictive model 1010 according to one aspect, manager system 110 at block 1070 can compare the sample of reconstructed data stream D1′ to the sample of input data stream D1 for determination of a reconstructive loss function, and a gradient of the reconstructive loss function with respect to the sample of the reconstructed data stream. Manager system 110 can backpropagate 1080 the gradient to decoder network D1 which can compute gradients of the loss function with respect to decoder weights of decoder network D1 and embedding E1. Decoder network DN1 can update decoder weights of decoder network D1 based on the computed decoder gradients. Decoder network DN1 can backpropagate 1090 the decoder gradients to encoder network EN1 which can compute encoder gradients of the loss function with respect to encoder weights of encoder network EN1. Encoder EN1 can update weights of encoder network EN1 based on the computed encoder network gradients.

For performing training of machine learning predictive model 1010 according to one aspect, manager system 110 at block 1170 can compare the sample of reconstructed data stream D2′ to the sample of input data stream D2 for determination of a reconstructive loss function, and a gradient of the reconstructive loss function with respect to the sample of the reconstructed data stream. Manager system 110 can backpropagate 1180 the gradient to decoder network D2 which can compute gradients of the loss function with respect to decoder weights of decoder network D2 and embedding E2. Decoder network DN2 can update decoder weights of decoder network D2 based on the computed decoder gradients. Decoder network DN2 can backpropagate 1190 the decoder gradients to encoder network EN2 which can compute encoder gradients of the loss function with respect to encoder weights of encoder network EN2. Encoder EN2 can update weights of encoder network EN2 based on the computed encoder network gradients.

Over the course of several training iterations in accordance with the training as described in connection with FIG. 4, the respective embedding E1 and embedding E2 can converge on values such that embedding E1 emulates embedding E2 and further so that embedding E2 emulates embedding E1. Embodiments herein recognize that with embedding E1 emulating embedding E2, reconstructed data stream D2′ can be produced by application of embedding E1 into decoder network DN2. Embodiments herein recognize that with embedding E1 emulating embedding E2, reconstructed data stream D1′ can be produced by application of embedding E2 into decoder network DN1.

On completion of training block 1103, manager system 110 can proceed to criterion block 1104. At criterion block 1104, manager system 110 can ascertain whether machine learning predictive model 1010 is performing satisfactorily (e.g., in terms of producing predictions having satisfactory accuracy) and therefore has been qualified for use in support of inferencing. At criterion block 1104, manager system 110 can ascertain whether machine learning predictive model 1010 is qualified for interpolating data stream data of data stream D1 from data stream D2 or vice versa.

For performing such determining, manager system 110 at criterion block 1104 can compare for a recently collected (e.g., within a time window of a current time) a sample of embedding E1 to a sample of embedding E2 to determine whether a context vector defining embedding E1 is within a threshold Euclidian distance from the context vector defining embedding E2.

Manager system 110 can qualify machine learning predictive model 1010 for interpolating data stream data of data stream D1 from data stream D2 and vice versa, where for a recent sample (within a threshold time window of the current time), the Euclidean distance of the context vector defining embedding E1 and the context vector defining embedding E2 are within a similarity threshold satisfying Euclidean distance of one another and/or where the respective reconstructed data streams D1′ and D2′ exhibit a threshold satisfying level of similarity with their respective original data streams D1 and D2. With criteria as described satisfied, manager system 110 can qualify machine learning predictive model 1010 for performing predictions as to values of data stream D2 based on data stream values of data stream D1 and vice versa. Embodiments herein recognize that the referenced criterion can serve as performance indicators of machine learning predictive model.

Where manager system 110 at criterion block 1104 determines that machine learning predictive model 1010 is qualified for predicting data stream D2 based on data stream D1, and vice versa, manager system 110 can proceed to updating block 1105. At updating block 1105, manager system 110 can update model status area 2125 of data repository 108 to reflect the status indicating that machine learning predictive model 1010 is now qualified for predicting data stream D1 based on data stream values of data stream D2 and vice versa.

On completion of updating block 1105, manager system 110 can proceed to return block 1110. Manager system 110 can also proceed to return block 1110 on determining at criterion block 1104 that machine learning predictive model 1010 is not qualified for performing predictions as to data stream D2 based on data stream D1 and vice versa.

At return block 1110, manager system 110 can return to a stage preceding block 1101 to collect and process next iterations of data stream data sent at send block 1401 from data sources 140A-140Z, as well as instances of command data sent from UE devices 150A-150Z at send block 1501 and/or sent at send block 1601 by API service endpoint 160.

Referring again to block 1102, manager system 110 at block 1102 can ascertain whether command data sent at block 1501 and/or 1601 has invoked inferencing. On determining that inferencing has been invoked, manager system 110 can proceed to inferencing block 1106. At block 1106, manager system 110 can confirm that machine learning predictive model 1010 has been qualified for performing the prediction specified in the command data by looking up the current status of machine learning predictive model 1010 as recorded in model status area 2125 of data repository 108.

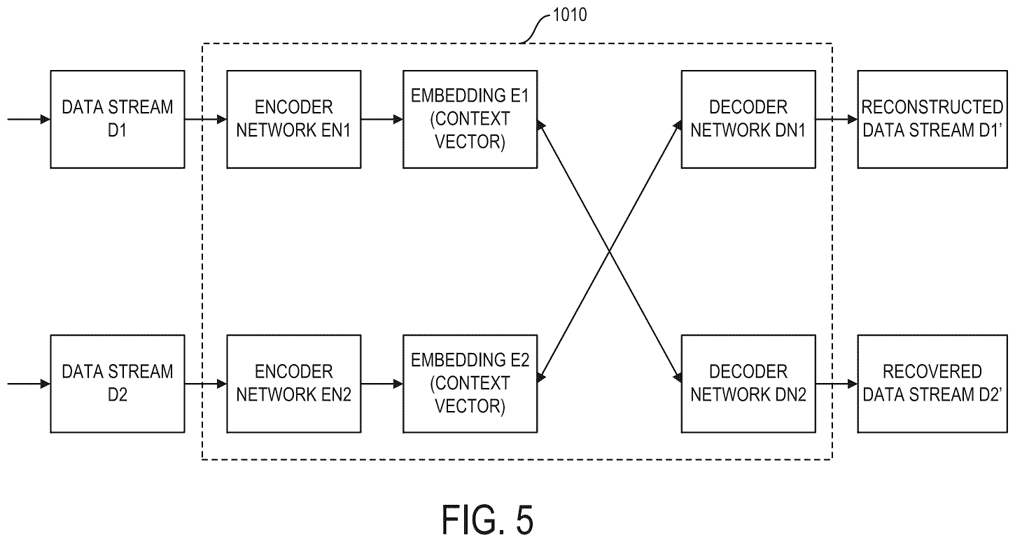

On confirming that machine learning predictive model 1010 is qualified for performing the requested predicting, manager system 110 can perform inferencing in a manner referenced in FIG. 5. In one scenario, data stream D2 may become unavailable, and thus when data stream D2 becomes unavailable the user can define command data sent at block 1501 to interpolate data stream D2 based on data stream D1. Additionally or alternatively, a service having API service endpoint 160 can, e.g., automatically detect the loss of data stream D2 and responsively can automatically send command data sent at block 1601 requesting that data stream D2 be interpolated based on data stream D1.

At inferencing block 1106 with machine learning predictive model 1010 having been qualified, manager system 110 can apply a current sample of data stream D1 to encoder network EN1 which responsively can produce embedding E1 defined by a context vector. Embedding E1 in turn can be input into decoder network DN2 and decoder network DN2 can produce recovered data stream D2 primed responsively to data stream D1 being input into encoder network EN1.

Similarly, with reference to FIG. 5, data stream D2 can be applied to encoder network EN2 which produces embedding E2 which embedding E2 can be input into decoder network DN1, which decoder network DN1 in turn can produce reconstructed data stream D1′ responsively to data stream D2 having been input into encoder network EN2.

At send block 1107, manager system 110 can send interpolated stream data resulting from the inferencing at block 1106 to one or more UE device of UE devices 150A-150A, and responsively, the one or more UE device can perform one or more action at action block 1502 in dependence on the interpolated stream data and can store the interpolated stream data at store block 1503.

At send block 1108, manager system 110 can send interpolated stream data resulting from the inferencing at block 1106 to one or more API service endpoint 160, and responsively, the one or more API service endpoint 160 can perform one or more action at action block 1602 in dependence on the interpolated stream data and can store the interpolated stream data at store block 1603.

In one example of an action at action block 1502 and/or action block 1602, manager system 110 can recognize a changed condition, e.g., via subjecting the interpolated stream data to pattern recognition and can control a mechanical system in response to the recognition. The mechanical system can include, e.g., a robot, an irrigation system, an agricultural treatment system, a roadway sign array, and the like. In one example, manager system 110 can recognize a condition via the described pattern recognition, e.g., a changed condition or specified condition in an agricultural geospatial area (e.g., crop) and can control a mechanical system, e.g., irrigation system or pesticide application system responsively to the condition being recognized.

On completion of send block 1108, manager system 110 can return to a stage preceding block 1101 and can iteratively perform the loop of block 1101-1108 for a time that inferencing is determined to be active at block 1102. On completion of block 1105 or block 1104 (‘no’ condition) manager system 110 can proceed to return block 1110. At return block 1110 manager system 110 can return to a stage preceding block 1101, and manager system 110 can iteratively perform the loop of block 1101-1110 for a deployment period of manager system. On completion of store block 1503, UE devices 150A-150Z can proceed return block 1504. At return block 1504, UE devices 150A-150Z can return to a stage preceding block 1501, and UE devices 150A-150Z can iteratively perform the loop of block 1501-1504 for a deployment period of UE devices 150A-150Z. On completion of store block 1603, one or more API service endpoint 160 can proceed return block 1604. At return block 1604, one or more API service endpoint 160 can return to a stage preceding block 1601, and one or more API service endpoint 160 can iteratively perform the loop of block 1601-1604 for a deployment period of one or more API service endpoint 160. On completion of send block 140 data sources 140A-140Z can proceed to return block 1402. At return block 1402, data sources 140A-140Z can return to a stage preceding block 1401, and data sources 140A-140Z can iteratively perform the loop of blocks 1401-1402 for a deployment period of data sources 140A-140Z.

With reference again to criterion block 1104, manager system 110 in one embodiment can activate alternate training of machine learning predictive model 1010 on the determination at criterion block 1104 that the Euclidean distance of embedding E1 and embedding E2 are not within a similarity threshold satisfying Euclidean distance of one another or where the respective reconstructed data streams D1′ and D2′ do not exhibit a threshold satisfying level of similarity with their respective original data streams D1 and D2.

According to the alternative training that can be triggered based on performance criterion of machine learning predictive model 1010 not being satisfied, cross-stream training can be activated based on performance criterion of machine learning predictive model 1010 not being satisfied. In the training depicted in FIG. 4, machine learning predictive model 1010 can calculate and backpropagate the loss between reconstructed data stream D1′ and data stream D1. Where cross-stream training is activated, machine learning predictive model 1010 can additionally or alternatively calculate and backpropagate the loss between samples of data stream D1 and D2, so that for subsequent inputs, the loss between samples of data stream D1 and data stream D2 is minimized. Trained as described, machine learning predictive model 1010, can learn the relationships between samples of stream D1 and samples of stream D2, even where the samples are dissimilar (as can be indicated by the Euclidian distance between embedding E1 and embedding E2 exceeding a threshold). Activating cross-stream training of machine learning predictive model 1010 responsively to performance degradation of the machine learning predictive model 1010 can improve the predictive performance of predictive model where, for example, a similarity between samples of data stream D1 and data stream D2 decreases as a result of an event. In one example, the locations of data sources of data sources 140A-140Z (e.g., defined by satellite camera devices), can change over time to increase a translation error between data stream samples of different data sources.

Various available tools, libraries, and/or services can be utilized for implementation of trained predictive models herein trained by machine learning. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs), support vector machines (SVM), Bayesian networks, and/or other machine learning technologies.

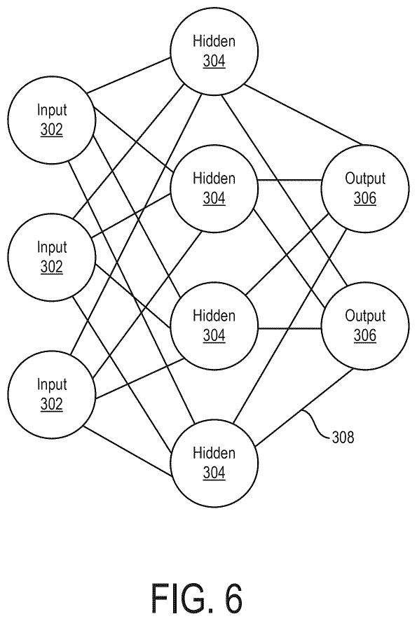

FIG. 6 is an illustration of an example ANN architecture for trained predictive models. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with predictive models herein.

Referring now to FIG. 6, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, backpropagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referred to as outcome training data as referenced in connection with predictive models herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer systems. Embodiments herein can employ use of a trained machine learning model for interpolating data stream data of a second stream based on data stream data of a first data stream and vice versa. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The computer implemented method also includes applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, where the first encoder network, the first decoder network, the second encoder network, and the second decoder network define a predictive model; determining an embedding loss function between the first embedding and the second embedding; finding a reconstructive loss function between the first reconstructed stream and the first data stream; calculating a reconstructive loss function between the second reconstructed stream and the second data stream; updating weights of the predictive model in dependence on the determining, the finding, and the calculating; repeating the applying, the inputting, the determining, the finding, the calculating, and the updating for multiple iterations of training of the predictive model using subsequent samples of the first data stream and the second data stream; deploying the predictive model; and interpolating the second data stream from the first data stream using the predictive model subsequent to the deploying. Other embodiments of this aspect include corresponding computer systems, apparatus, and computer programs recorded on one or more computer storage devices, each configured to perform the actions of the methods.

Implementations may include one or more of the following features. The computer implemented method where the method includes synchronizing the first data stream and the second data stream in performing the applying, and the inputting for the multiple iterations of the training of the predictive model. The method includes time synchronizing the first data stream and the second data stream in performing the applying, and the inputting for the multiple iterations of the training of the predictive model. The interpolating includes applying a sample of the first data stream to the first encoder network to produce a first data stream embedding and inputting the first data stream embedding to the second decoder network. The finding the reconstructive loss function between the first reconstructed stream and the first data stream includes finding a contrastive loss function between the first reconstructed stream and the first data stream. The finding the reconstructive loss function between the first reconstructed stream and the first data stream includes regularizing the first embedding and the second embedding in a normal distribution using Kullback-Leibler (kl) loss. The finding the reconstructive loss function between the first reconstructed stream and the first data stream includes finding a contrastive loss function between the first reconstructed stream and the first data stream and regularizing the first embedding and the second embedding in a normal distribution using kl loss. The method includes synchronizing the first data stream and the second data stream in performing the applying, and the inputting for the multiple iterations of the training of the predictive model, where the synchronizing includes evaluating candidate samples of the first data stream and/or the second data stream for association in a training iteration according to a timestamp difference factor. The method includes synchronizing the first data stream and the second data stream in performing the applying, and the inputting for the multiple iterations of the training of the predictive model, where the synchronizing includes evaluating candidate samples of the first data stream and/or the second data stream for association in a training iteration according to an image translation factor. The method includes synchronizing the first data stream and the second data stream in performing the applying, and the inputting for the multiple iterations of the training of the predictive model, where the synchronizing includes evaluating candidate samples of the first data stream and/or the second data stream for association in a training iteration according to an affinity factor, where according to the affinity factor, a reconstructed instance of a sample of the first data stream at a certain time is produced based on sample images from multiple data sources at differentiated times, and a difference is determined between the reconstructed instance of the sample of the first data stream at the certain time and an actual sample of the first data stream at the certain time. The method includes synchronizing the first data stream and the second data stream in performing the applying, and the inputting for the multiple iterations of the training of the predictive model, where the synchronizing includes evaluating candidate samples of the first data stream and/or the second data stream for association in a training iteration according to multiple factors, where the multiple factors include a timestamp factor, and a translation factor. The method includes synchronizing the first data stream and the second data stream in performing the applying, and the inputting for the multiple iterations of the training of the predictive model, where the synchronizing includes evaluating candidate samples of the first data stream and/or the second data stream for association in a training iteration according to multiple factors, where the multiple factors include a timestamp factor, a translation factor, and an affinity factor. The method includes evaluating performance of the predictive model and activating cross-stream training of the predictive model responsively to the evaluating. The method includes evaluating performance of the predictive model and activating cross-stream training of the predictive model responsively to the evaluating, where the evaluating includes determining a Euclidian distance between the first embedding and the second embedding. Implementations of the described techniques may include hardware, a method or process, or computer software on a computer-accessible medium.

The system also includes a memory; at least one processor in communication with the memory; and program instructions executable by one or more processor via the memory to perform a method may include: applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, where the first encoder network, the first decoder network, the second encoder network, and the second decoder network define a predictive model; determining an embedding loss function between the first embedding and the second embedding; finding a reconstructive loss function between the first reconstructed stream and the first data stream; calculating a reconstructive loss function between the second reconstructed stream and the second data stream; updating weights of the predictive model in dependence on the determining, the finding, and the calculating; repeating the applying, the inputting, the determining, the finding, the calculating, and the updating for multiple iterations of training of the predictive model using subsequent samples of the first data stream and the second data stream; deploying the predictive model; and interpolating the second data stream from the first data stream using the predictive model subsequent to the deploying. Other embodiments of this aspect include corresponding computer systems, apparatus, and computer programs recorded on one or more computer storage devices, each configured to perform the actions of the methods.

Implementations may include one or more of the following features. The system where the method includes synchronizing the first data stream and the second data stream in performing the applying, and the inputting for the multiple iterations of the training of the predictive model. The method includes time synchronizing the first data stream and the second data stream in performing the applying, and the inputting for the multiple iterations of the training of the predictive model. The interpolating includes applying a sample of the first data stream to the first encoder network to produce a first data stream embedding and inputting the first data stream embedding to the second decoder network. The finding the reconstructive loss function between the first reconstructed stream and the first data stream includes finding a contrastive loss function between the first reconstructed stream and the first data stream. Implementations of the described techniques may include hardware, a method or process, or computer software on a computer-accessible medium.

One general aspect includes a computer readable storage medium readable by one or more processing circuit and storing instructions for execution by one or more processor for performing a method may include: applying a first data stream to a first encoder network that produces a first embedding of the first data stream and inputting the first embedding to a first decoder network that produces a first reconstructed stream of the first data stream; inputting a second data stream to a second encoder network that produces a second embedding of the second data stream and inputting the second embedding to a second decoder network that produces a second reconstructed stream of the second data stream, where the first encoder network, the first decoder network, the second encoder network, and the second decoder network define a predictive model; determining an embedding loss function between the first embedding and the second embedding; finding a reconstructive loss function between the first reconstructed stream and the first data stream; calculating a reconstructive loss function between the second reconstructed stream and the second data stream; updating weights of the predictive model in dependence on the determining, the finding, and the calculating; repeating the applying, the inputting, the determining, the finding, the calculating, and the updating for multiple iterations of training of the predictive model using subsequent samples of the first data stream and the second data stream; deploying the predictive model; and interpolating the second data stream from the first data stream using the predictive model subsequent to the deploying. Other embodiments of this aspect include corresponding computer systems, apparatus, and computer programs recorded on one or more computer storage devices, each configured to perform the actions of the methods.

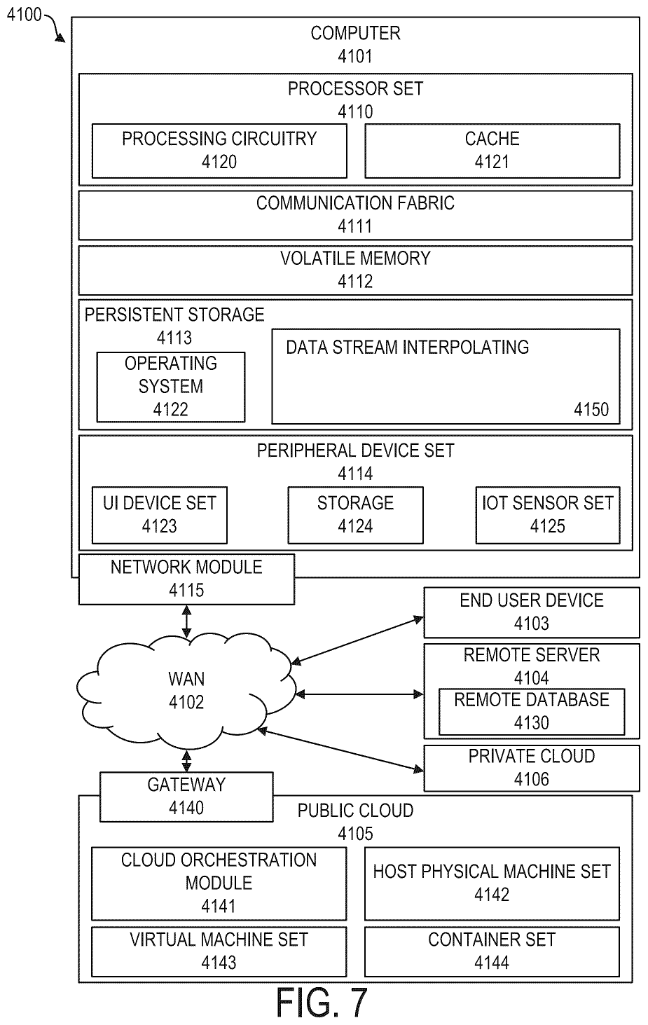

In reference to FIG. 7 there is set forth a description of a computing environment 4100 that can include one or more computer 4101. In one example, a computing node as set forth herein can be provided in accordance with computer 4101 as set forth in FIG. 7.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 7. In one aspect, a computing environment 4100 contains an example of an environment for the execution of at least some of the computer code involved in performing the inventive methods, such as code 4150 for performing data stream interpolating described with reference to FIGS. 1-6. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IOT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101) and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
applying a first data stream to a first encoder network that produces a first embedding of the first data stream and inputting the first embedding to a first decoder network that produces a first reconstructed stream of the first data stream;
inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model;
determining an embedding loss function between the first embedding and the second embedding;
finding a reconstructive loss function between the first reconstructed stream and the first data stream;
calculating a reconstructive loss function between the second reconstructed stream and the second data stream;
updating weights of the predictive model in dependence on the determining, the finding, and the calculating;
repeating the applying, the inputting, the determining, the finding, the calculating, and the updating for multiple iterations of training of the predictive model using subsequent samples of the first data stream and the second data stream;
deploying the predictive model; and
interpolating the second data stream from the first data stream using the predictive model subsequent to the deploying.

2. The computer implemented method of claim 1, wherein the method includes synchronizing the first data stream and the second data stream in performing the applying, and the inputting for the multiple iterations of the training of the predictive model.

3. The computer implemented method of claim 1, wherein the method includes time synchronizing the first data stream and the second data stream in performing the applying, and the inputting for the multiple iterations of the training of the predictive model.

4. The computer implemented method of claim 1, wherein the interpolating includes applying a sample of the first data stream to the first encoder network to produce a first data stream embedding and inputting the first data stream embedding to the second decoder network.

5. The computer implemented method of claim 1, wherein the finding the reconstructive loss function between the first reconstructed stream and the first data stream includes finding a contrastive loss function between the first reconstructed stream and the first data stream.

6. The computer implemented method of claim 1, wherein the finding the reconstructive loss function between the first reconstructed stream and the first data stream includes regularizing the first embedding and the second embedding in a normal distribution using Kullback-Leibler (KL) loss.

7. The computer implemented method of claim 1, wherein the finding the reconstructive loss function between the first reconstructed stream and the first data stream includes finding a contrastive loss function between the first reconstructed stream and the first data stream and regularizing the first embedding and the second embedding in a normal distribution using KL loss.

8. The computer implemented method of claim 1, wherein the method includes synchronizing the first data stream and the second data stream in performing the applying, and the inputting for the multiple iterations of the training of the predictive model, wherein the synchronizing includes evaluating candidate samples of the first data stream and/or the second data stream for association in a training iteration according to a timestamp difference factor.

9. The computer implemented method of claim 1, wherein the method includes synchronizing the first data stream and the second data stream in performing the applying, and the inputting for the multiple iterations of the training of the predictive model, wherein the synchronizing includes evaluating candidate samples of the first data stream and/or the second data stream for association in a training iteration according to an image translation factor.

10. The computer implemented method of claim 1, wherein the method includes synchronizing the first data stream and the second data stream in performing the applying, and the inputting for the multiple iterations of the training of the predictive model, wherein the synchronizing includes evaluating candidate samples of the first data stream and/or the second data stream for association in a training iteration according to an affinity factor, wherein according to the affinity factor, a reconstructed instance of a sample of the first data stream at a certain time is produced based on sample images from multiple data sources at differentiated times, and a difference is determined between the reconstructed instance of the sample of the first data stream at the certain time and an actual sample of the first data stream at the certain time.

11. The computer implemented method of claim 1, wherein the method includes synchronizing the first data stream and the second data stream in performing the applying, and the inputting for the multiple iterations of the training of the predictive model, wherein the synchronizing includes evaluating candidate samples of the first data stream and/or the second data stream for association in a training iteration according to multiple factors, wherein the multiple factors include a timestamp factor, and a translation factor.

12. The computer implemented method of claim 1, wherein the method includes synchronizing the first data stream and the second data stream in performing the applying, and the inputting for the multiple iterations of the training of the predictive model, wherein the synchronizing includes evaluating candidate samples of the first data stream and/or the second data stream for association in a training iteration according to multiple factors, wherein the multiple factors include a timestamp factor, a translation factor, and an affinity factor.

13. The computer implemented method of claim 1, wherein the method includes evaluating performance of the predictive model and activating cross-stream training of the predictive model responsively to the evaluating.

14. The computer implemented method of claim 1, wherein the method includes evaluating performance of the predictive model and activating cross-stream training of the predictive model responsively to the evaluating, wherein the evaluating includes determining a Euclidian distance between the first embedding and the second embedding.

15. A system comprising:
a memory;
at least one processor in communication with the memory; and
program instructions executable by one or more processor via the memory to perform a method comprising:
applying a first data stream to a first encoder network that produces a first embedding of the first data stream and inputting the first embedding to a first decoder network that produces a first reconstructed stream of the first data stream;
inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model;
determining an embedding loss function between the first embedding and the second embedding;
finding a reconstructive loss function between the first reconstructed stream and the first data stream;
calculating a reconstructive loss function between the second reconstructed stream and the second data stream;
updating weights of the predictive model in dependence on the determining, the finding, and the calculating;
repeating the applying, the inputting, the determining, the finding, the calculating, and the updating for multiple iterations of training of the predictive model using subsequent samples of the first data stream and the second data stream;
deploying the predictive model; and
interpolating the second data stream from the first data stream using the predictive model subsequent to the deploying.

16. The system of claim 15, wherein the method includes synchronizing the first data stream and the second data stream in performing the applying, and the inputting for the multiple iterations of the training of the predictive model.

17. The system of claim 15, wherein the method includes time synchronizing the first data stream and the second data stream in performing the applying, and the inputting for the multiple iterations of the training of the predictive model.

18. The system of claim 15, wherein the interpolating includes applying a sample of the first data stream to the first encoder network to produce a first data stream embedding and inputting the first data stream embedding to the second decoder network.

19. The system of claim 15, wherein the finding the reconstructive loss function between the first reconstructed stream and the first data stream includes finding a contrastive loss function between the first reconstructed stream and the first data stream.

20. A computer program product comprising:
a computer readable storage medium readable by one or more processing circuit and storing instructions for execution by one or more processor for performing a method comprising:
applying a first data stream to a first encoder network that produces a first embedding of the first data stream and inputting the first embedding to a first decoder network that produces a first reconstructed stream of the first data stream;
inputting a second data stream to a second encoder network that produces a second embedding of the second data stream and inputting the second embedding to a second decoder network that produces a second reconstructed stream of the second data stream, wherein the first encoder network, the first decoder network, the second encoder network, and the second decoder network define a predictive model;
determining an embedding loss function between the first embedding and the second embedding;
finding a reconstructive loss function between the first reconstructed stream and the first data stream;
calculating a reconstructive loss function between the second reconstructed stream and the second data stream;
updating weights of the predictive model in dependence on the determining, the finding, and the calculating;
repeating the applying, the inputting, the determining, the finding, the calculating, and the updating for multiple iterations of training of the predictive model using subsequent samples of the first data stream and the second data stream;
deploying the predictive model; and
interpolating the second data stream from the first data stream using the predictive model subsequent to the deploying.
